(19) United States
(12) Patent Application Publication
(10) Pub. No.: US 2007/0159536 A1
(43) Pub. Date: Jul. 12, 2007

(54) White balance control method

(75) Inventor: Wen Kuo Lin, Taipei (TW)

Correspondence Address: TROXELL LAW OFFICE PLLC, SUITE 1404, 5205 LEESBURG PIKE, FALLS CHURCH, VA, 22041, US

(73) Assignee: SMedia Technology Corporation

(21) Appl. No.: 11/329,152

(22) Filed: Jan. 11, 2006

(51) Int. Cl. H04N 9/73

(52) U.S. Cl. 348/223.1

(57) ABSTRACT

A white balance control method is disclosed. The method first sets an initial white balance setting. Secondly, based on the white balance setting, an image is obtained. Both averaged RGB values of the whole image and white pixel are obtained. Information of both averaged RGB values of the whole image and white pixel are respectively used to calculate white balance information. Thirdly, both white balance information of the whole image and the white pixel RGB are used to determine whether the current white balance status matches the actual ambient lighting condition or not. If the determination result shows there is a need to select a new white balance status, a new white balance setting is then set. Finally, the procedure is returned back to acquire a new image and the above steps are repeated. The disclosure of the present invention can be applied to an image processing apparatus and method.

### BACKGROUND OF THE INVENTION

1. Field of the Invention

The present invention relates generally to an automatic white balance adjustment method, and more particularly, to an automatic white balance adjustment method for adjusting a white balance according to light sources of different color temperatures. The disclosure of the present invention can be applied to an image processing apparatus and method.

2. Description of the Prior Art

A chromatic adaptation of the human visual system (HVS) is a characteristic for people to perceive a white surface under light sources of different color temperatures as white. In order to mimic the chromatic adaptation of the HVS, each digital imaging sensing device needs to provide a white balance control method for acquiring digital images that resemble scenes what people actually perceived at that instance.

FIG. 1 is a flow chart showing the steps for a conventional white balance control method using the whole image. The procedure first sets an initial white balance setting, as shown in step S10. In step S12, an image is obtained. In step S14, averaged RGB (red (R), green (G) and blue (B)) values of the whole image are obtained. In step S16, the averaged RGB values are used to calculate white balance information.

In step S18, the white balance information is used to determine whether the current white balance status matches actual ambient lighting condition or not. In step S20, if there is no need to vary the white balance settings, the procedure goes back to step S12 to acquire a new image; otherwise the procedure goes to step S22. In step S22, if there is a need to vary the white balance setting to reflect the actual ambient lighting condition, then a new white balance setting is set. Finally, the procedure is returned back to acquire a new image and the above steps are repeated.

FIG. 2 is a flow chart showing the steps for another white balance control method using white pixels. The procedure first sets an initial white balance setting, as shown in step S40. In step S42, an image is obtained. In step S44, white pixels in the image are found. In step S46, averaged RGB values of the white pixels are obtained. In step S48, the averaged RGB values are used to calculate white balance information.

In step S50, the white balance information is used to determine whether the current white balance status matches actual ambient lighting condition or not. In step S52, if there is no need to vary the white balance settings, the procedure goes back to step S42 to acquire a new image; otherwise the procedure goes to step S54. In step S54, if there is a need to vary the white balance setting to reflect actual ambient lighting condition, then a new white balance setting is set. Finally, the procedure is returned back to acquire a new image and the above steps are repeated.

Although the above two white balance control schemes are commonly used, each of them has its own disadvantages. The first method that uses whole image RGB information to determine white balance status is likely to produce incorrect white balance judgment if there are some dominant colors in the acquired scene, such as sunset, forest or blue sky. The result is that images will be modified to have equal average RGB values and will look unnatural. Whereas, the second method that uses white pixel RGB information to determine white balance status could not give proper result if the number of white pixels found does not exceed a certain fraction of the total pixel number.

### SUMMARY OF THE INVENTION

An objective of the present invention is to solve the above-mentioned problems and to provide a white balance control method that correlates two conventional control schemes and enhances improvements to form a novel white balance control method that is more robust and can more accurately reflect the ambient lighting condition.

The present invention achieves the above-indicated objective by providing a white balance control method. The method first sets an initial white balance setting. Secondly, based on the white balance setting, an image is obtained. Both averaged RGB values of the whole image and white pixels are obtained. Information of both averaged RGB values of the whole image and white pixels are respectively used to calculate white balance information. Thirdly, both white balance information of the whole image and the white pixel RGB are used to determine whether the current white balance status matches the actual ambient lighting condition or not. If the determination result shows there is a need to select a new white balance status, a new white balance setting is then set. Finally, the procedure is returned back to acquire a new image and the above steps are repeated.

The following detailed description, given by way of example and not intended to limit the invention solely to the embodiments described herein, will best be understood in conjunction with the accompanying drawings.

### BRIEF DESCRIPTION OF THE DRAWINGS

FIG. 1 is a flow chart showing the steps for a conventional white balance control method using the whole image.

FIG. 2 is a flow chart showing the steps for another conventional white balance control method using white pixels.

FIG. 3 is a flow chart showing the steps for a white balance control method of the present invention.

FIGS. 4A and 4B are a flow chart showing a preferred embodiment of the white balance control method of the present invention.

FIG. 5 is a conceptual diagram for illustrating branching white balance control statuses of the present invention.

FIGS. 6A and 6B are a flow chart showing a preferred scheme of a detail determination procedure of the present invention.

### DETAILED DESCRIPTION OF THE PREFERRED EMBODIMENTS

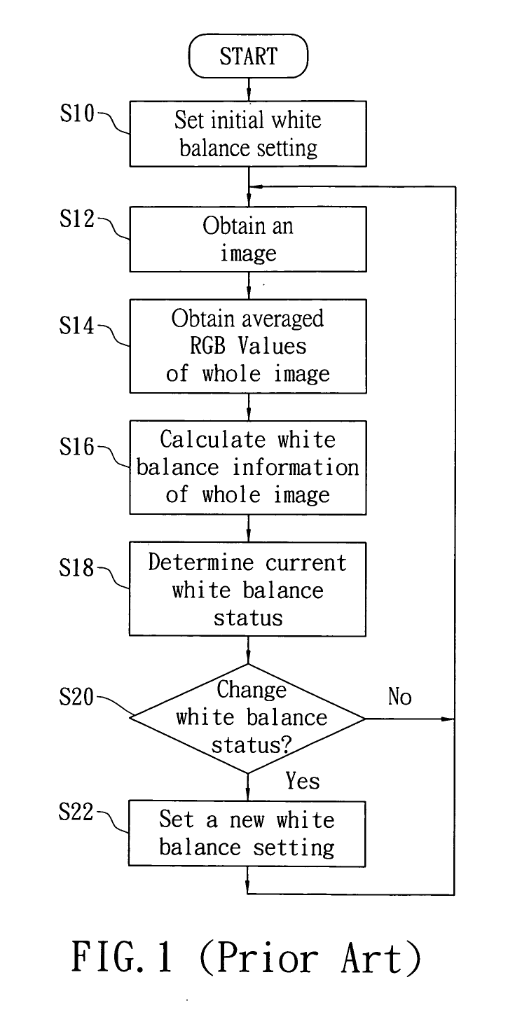

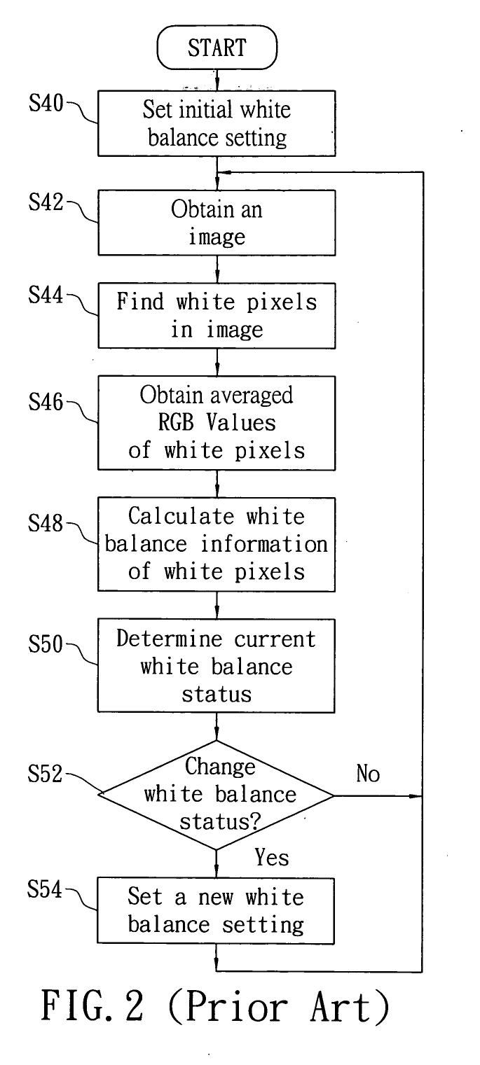

The present invention discloses a white balance control method that correlates both control schemes shown in FIGS. 1 and 2 and enhances improvements to form a novel white balance control method that is more robust and can more accurately reflect the ambient lighting condition.

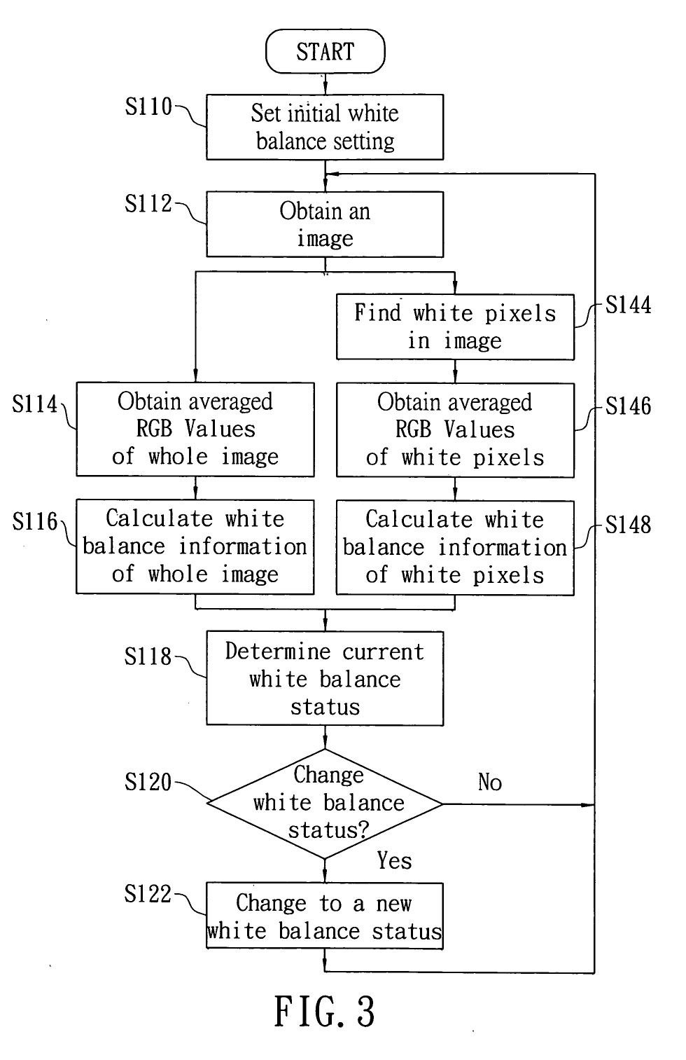

FIG. 3 is a flow chart showing the steps for a white balance control method of the present invention. The procedure first sets an initial white balance setting, as shown in step S110.

Secondly, based on the white balance setting, an image is obtained, as shown in step S112. Both averaged RGB values of the whole image and white pixel are obtained, as shown in step S114, S144 and S146. Information of both averaged RGB values of the whole image and white pixel are respectively used to calculate white balance information, as shown in step S116 and S148.

Thirdly, both white balance information of the whole image and the white pixel RGB are used to determine whether the current white balance status matches the actual ambient lighting condition or not, as shown in step S118. In step S120, if there is no need to change the current white balance setting, the procedure goes back to step S112; otherwise the procedure goes to step S122. If the determination result shows there is a need to select a new white balance status, a new white balance setting is then set, as shown in step S122.

Finally, the procedure is returned back to acquire a new image and the above steps are repeated.

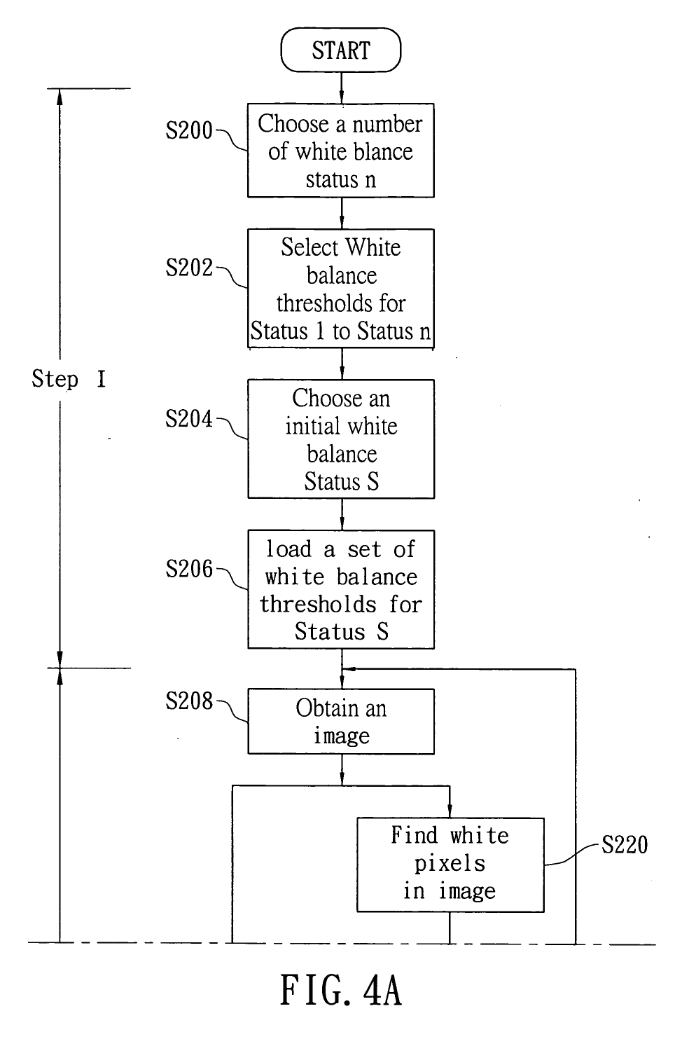

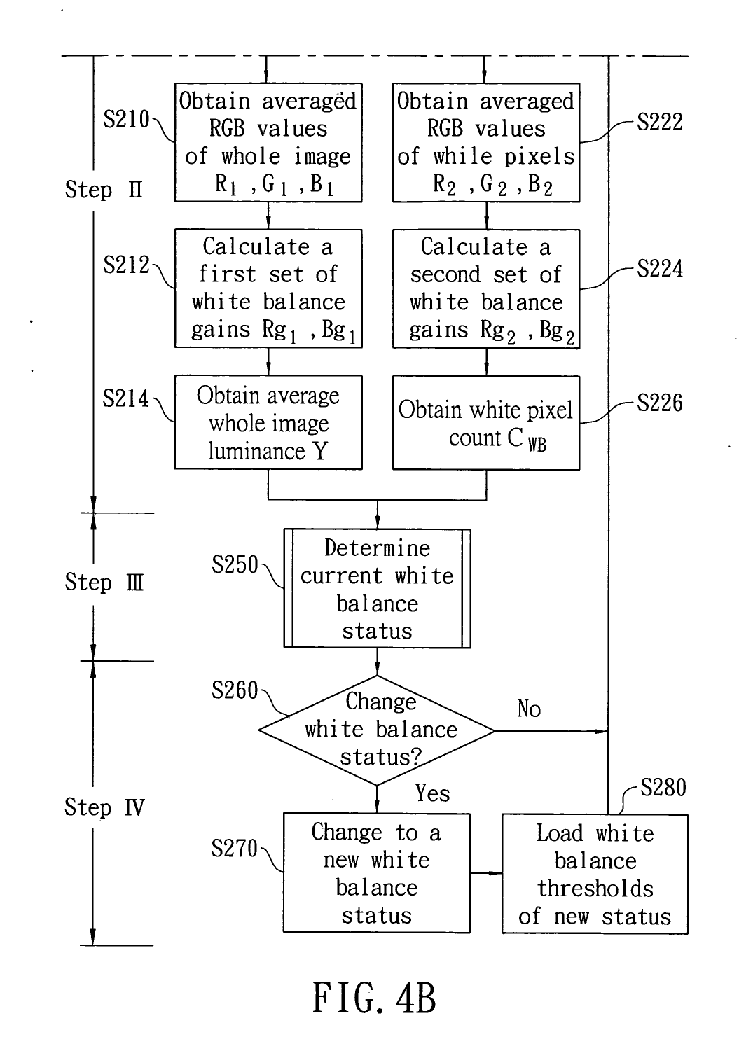

FIG. 4 is a flow chart showing a preferred embodiment of the white balance control method of the present invention. The whole control procedure is divided into four major steps.

As shown in Step I, the white balance control method of the preferred embodiment is set to initial conditions. These initial conditions include choosing a number of white balance control statuses n, selecting white balance conditional thresholds for Status 1 to Status n, choosing an initial white balance Status S, and loading a set of white balance conditional thresholds for Status S, as shown in step S200, S202, S204 and S206 sequentially. The white balance conditional thresholds for Status 1 to Status n are obtained empirically.

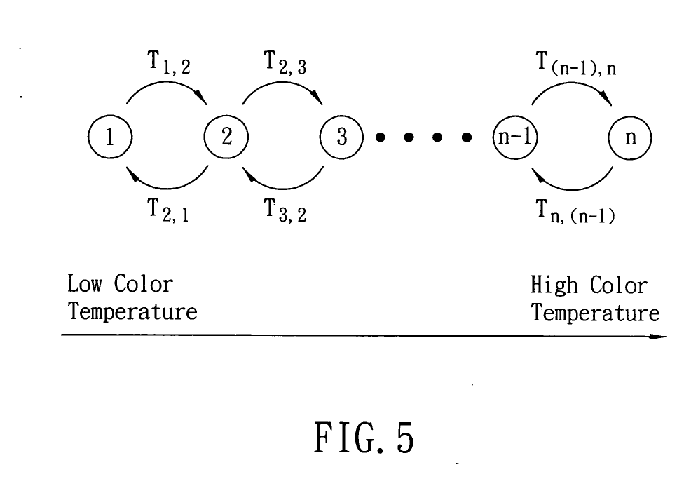

FIG. 5 is a conceptual diagram for illustrating branching white balance control statuses. As shown in FIG. 5, the chosen number of white balance control statuses is n, which means that there are n states of white balance settings to reflect the ambient lighting conditions from low color temperatures to high color temperatures. The branching conditional thresholds are depicted as T_{(n-1),n} for branching from Status (n−1) to Status n and T_{n,(n+1)} for branching from Status n to Status (n+1).

In Step II, an image is acquired based on a current white balance control status, as shown in step S208. Then, needed information for determining white balance control status is obtained, as shown in following descriptions and steps. There are two sets of white balance information gathered here. The white balance information of a first set is obtained from the whole image including averaged whole image RGB values R₁, G₁ and B₁, as shown in step S210; white balance gains, a first red gain Rg₁ and a first blue gain Bg₁ of the first set, in step S212; and luminance Y of the averaged whole image, in step S214. The white balance gains Rg₁ and Bg₁ are respectively given by Rg₁=G₁/R₁ and Bg₁=G₁/B₁, and luminance Y is give by Y=C₁×R₁+C₂×G₁+C₃×B₁, where C₁+C₂+C₃=1.

Furthermore, the white balance information of a second set is obtained from white pixels in the image including averaged white pixel RGB values R₂, G₂ and B₂, as shown in step S220 and S222; the second set of white balance gains, a second red gain Rg₂ and a second blue gain Bg₂, in step S224; and the number of the white pixels C_{WB}, in step S226. The white balance gains Rg₂ and Bg₂ are respectively given by Rg₂=G₂/R₂ and Bg₂=G₂/B₂.

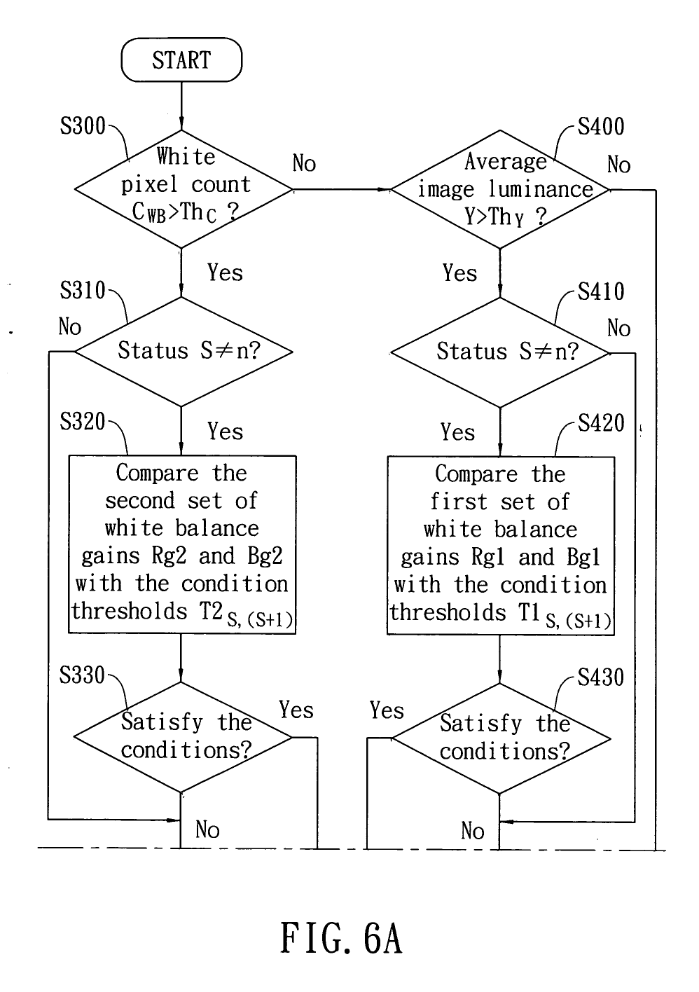

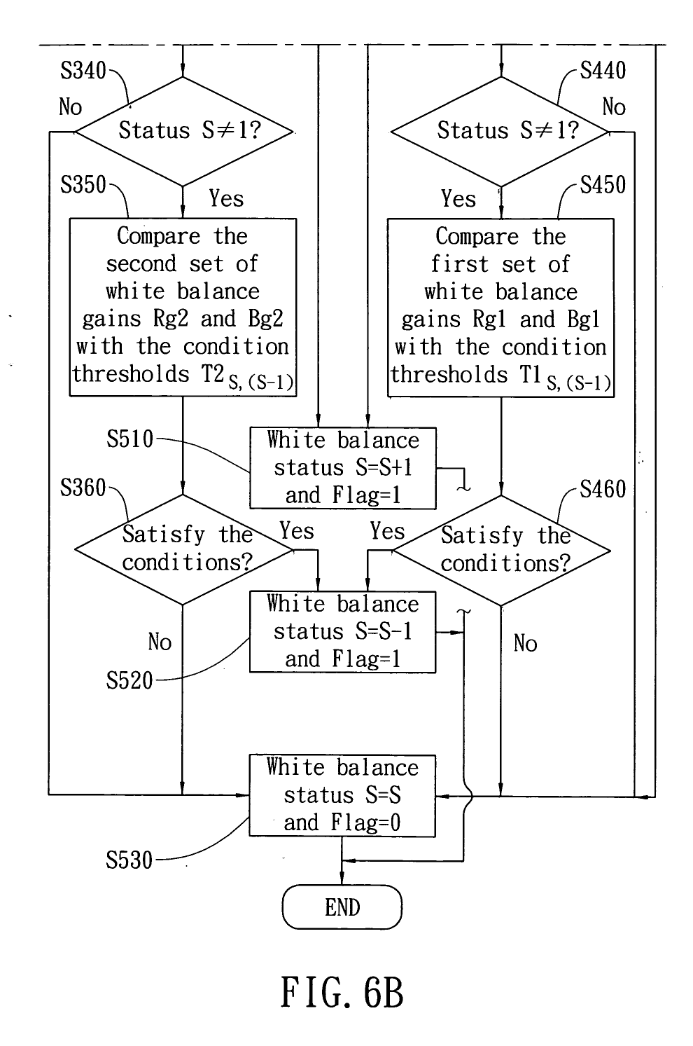

In Step III, the obtained white balance information in Step II is used to determine whether the current white balance setting can reflect the ambient lighting condition or not, as shown in step S250. FIG. 6 is a flow chart showing a preferred scheme of a detail determination procedure in step S250. Firstly, the white pixel count C_{WB} is compared to a threshold Th_{c}, as shown in step S300. If C_{WB} exceeds Th_{c}, the white balance information of the white pixel RGB is used to determine the white balance setting and the procedure goes to step S310. Otherwise, if C_{WB} does not exceeds Th_{c}, then the white balance information of the whole image is used in determination and the procedure goes to step S400. This will ensure there are enough detected white pixels in an image to reflect the ambient lighting condition.

As shown in step S310, if there are enough white pixels detected and the preset Status S does not equal to n (not at the highest status), then the second set of white balance gains Rg₂ and Bg₂ are compared to conditional thresholds T2_{s,(s+1)} and the procedure goes to step S320. In step S330, if the comparison is satisfied, then the white balance control Status S is changed to S=S+1 and a flag signal Flag is set to 1 indicating that the white balance control statuses needs to be changed and the procedure goes to step S510. Otherwise, if the comparison in step S330 is not satisfied or Status S equals to n, then Status S is checked to see if the Status S equals to 1 and the procedure goes to step S340. In step 340, if Status S does not equal to 1, Rg₂ and Bg₂ are compared to conditional thresholds T2_{s,(s-1)} and the procedure goes to step S350. In step S360, if the comparison is satisfied, then the white balance control Status S is changed to S=S−1 and the flag signal Flag is set to 1 and the procedure goes to step S520. Otherwise, if the threshold comparison in step S360 is not satisfied or Status S equals to 1, then the current white balance setting will not be changed, i.e., S=S and Flag=0 and the procedure goes to step S530.

One practical example of the comparison of white balance gains Rg₂ and Bg₂ with conditional thresholds T2_{s,(s+1)} is given as Rg₂>=1.00 and Bg₂<=1.00. The comparison will be satisfied if the ambient lighting condition appears to have higher color temperature than what the current Status S reflects. Furthermore, one example of the comparison of white balance gains Rg₂ and Bg₂ with conditional thresholds T2_{s,(s-1)} is given as Rg₂<=1.00 and Bg₂>=1.00. The comparison will be true if the ambient lighting condition appears to have lower color temperature than what the current Status S reflects. Moreover, relations of the comparison between the second set of white balance gains and conditional thresholds are not restricted to the above descriptions. A different relation, as well as different thresholds, can also be chosen.

In the case that there are not enough white pixels in the obtained image, the white balance information of the whole image RGB will be used to detect the ambient lighting condition. Firstly, in step S400 of FIG. 6, the luminance Y of the averaged whole image is checked with a threshold Thy to verify if the luminance Y is high enough to have valid color information. If the luminance Y is not greater than threshold Thy, then the white balance control Status S will not be changed and Flag is set to 0 and the procedure goes to step S530; otherwise the procedure goes to step S410. In step S410, if the luminance Y exceeds threshold Thy and the current Status S does not equal to n, the first set of white balance gains Rg₁ and Bg₁ are compared to conditional thresholds T1_{s,(s+1)} and the procedure goes to step S420. In step S430, if the comparison is satisfied, the white balance control status is changed to S=S+1 and the Flag is set to 1 and the procedure goes to step S510. Otherwise, if the comparison in step S430 is not satisfied or Status S equals to n, then the Status S is checked to see if S equals to 1 and the procedure goes to step S440. In step S440, if S does not equal to 1, the first set of white balance gains are compared to conditional threshold T1_{s,(s-1)} and the procedure goes to step S450. In step S460, if the comparison is satisfied, the white balance control Status S is set to as S=S−1 and the flag signal is set to Flag=1 and the procedure goes to step S520. Otherwise, if the threshold comparison in step S460 is not satisfied or S=1, the current white balance control Status S will remain unchanged and the flag signal is set to Flag=0 and the procedure goes to step S530.

One practical example of the comparison of the first set of white balance gains Rg₁ and Bg₁ with conditional thresholds T2_{s,(s+1)} is given as [Rg₁<2.5 and Bg₁>0.5 and (Rg₁>=1.0 or Bg₁<1.0)]. On the other hand, one example of the comparison of white balance gains Rg₁ and Bg₁ with conditional thresholds T2_{s,(s-1)} is given as [Rg₁>0.5 and Bg₁<2.5 and (Rg₁<1.0 or Bg₁>=1.0)]. These comparisons shown above can ensure to minimize the contribution of some dominant colors in image to affect the accuracy of condition comparison. Furthermore, relations of the comparison between the first set of white balance gains and conditional thresholds are not restricted to the above descriptions. A different relation, as well as different thresholds, can also be chosen.

In Step IV of FIG. 4, after the white balance control status is determined, in step S260, if there is a need to change current white balance control status, the white balance settings are modified and the procedure goes to step S270. In step S280, a corresponding set of white balance conditional thresholds to another status are retrieved from a table, and the white balance control procedure is returned back to Step II. Otherwise, if there is no need to vary the white balance setting, the white balance control procedure is returned to Step II.

As set forth hereinabove, according to the present invention, the ambient lighting condition of different color temperatures is determined correctly, so that the white balance can be accurately adjusted according to the ambient lighting condition.

What is claimed is:

1. A white balance control method, comprising the steps of:
choosing a number of white balance control statuses from Status 1 to Status n to reflect ambient lighting conditions from low color temperatures to high color temperatures;
selecting white balance conditional thresholds for Status 1 to Status n;
choosing an initial white balance status from the white balance control statuses;
loading a set of white balance conditional thresholds for the initial white balance status;
obtaining an image based on the initial white balance status or a current white balance control status depicted as Status S;
obtaining a first white balance information having averaged whole image RGB values, first white balance gains and luminance from the image;
obtaining a second white balance information having averaged white pixel RGB values, second white balance gains and the number of white pixels from the image;
determining whether the current white balance control status matches the actual ambient lighting condition or not, and obtaining a determination, based on the first and second sets white balance information;
obtaining a further image if the determination shows there is no need to change the current white balance control status; and
setting a new white balance control status, loading new white balance conditional thresholds of the new white balance control status and obtaining a new image if the determination shows there is a need to change the current white balance control status.

2. The white balance control method as recited in claim 1, wherein the step of determining whether the current white balance control status matches the actual ambient lighting condition or not, further comprising the steps of:
comparing the number of white pixels to a first threshold;
obtaining the determination based on the second set white balance information if the number of white pixels exceeds the first threshold;
comparing the second white balance gains to the white balance conditional thresholds of the white balance control statuses Status S and Status S+1;
changing the white balance control Status S to S=S+1 and a flag signal Flag is set to 1 if the comparison of the second white balance gains to the white balance conditional thresholds of Status S and Status S+1 is satisfied;
checking the current white balance control Status S to see if the S equals to 1 if the comparison of the second white balance gains to the white balance conditional thresholds of Status S and Status S+1 is not satisfied or Status S equals to n;
comparing the second white balance gains to the white balance conditional thresholds of the white balance control statuses Status S−1 and Status S if Status S does not equal to 1; and
changing the white balance control Status S to S=S−1 and the flag signal Flag is set to 1 if the comparison of the second white balance gains to the white balance conditional thresholds of Status S and Status S−1 is satisfied.

3. The white balance control method as recited in claim 2, wherein the comparison of the second white balance gains to the white balance conditional thresholds of Status S and Status S+1 is given as a red gain of the second white balance gains is not less than 1.00 and a blue gain of the second white balance gains is not greater than 1.00.

4. The white balance control method as recited in claim 2, wherein the comparison of the second white balance gains to the white balance conditional thresholds of Status S−1 and Status S is given as the red gain of the second white balance gains is not greater than 1.00 and the blue gain of the second white balance gains is not less than 1.00.

5. The white balance control method as recited in claim 2, wherein the step of determining whether the current white balance control status matches the actual ambient lighting condition or not, further comprising the steps of:
obtaining the determination based on the first set white balance information if the number of white pixels does not exceeds the first threshold;
checking the luminance of the first white balance information with a second threshold to verify if the luminance is high enough to have valid color information;
comparing the first white balance gains to the white balance conditional thresholds of the white balance control statuses Status S and Status S+1 if the luminance exceeds the second threshold and the current Status S does not equal to n;
changing the white balance control Status S to S=S+1 and the flag signal Flag is set to 1 if the comparison of the first white balance gains to the white balance conditional thresholds of Status S and Status S+1 is satisfied;
checking the current white balance control Status S to see if the S equals to 1 if the comparison of the first white balance gains to the white balance conditional thresholds of Status S and Status S+1 is not satisfied or Status S equals to n; and
comparing the first white balance gains to the white balance conditional thresholds of the white balance control statuses Status S and Status S−1 if S does not equal to 1; and
changing the white balance control Status S to S=S−1 and the flag signal Flag is set to 1 if the comparison of the first white balance gains to the white balance conditional thresholds Status S and Status S−1 is satisfied.

6. The white balance control method as recited in claim 5, wherein the comparison of the first white balance gains to the white balance conditional thresholds of Status S and Status S+1 is given as a red gain of the first white balance gains is less than 2.5 and a blue gain of the first white balance gains is greater than 0.5 and the red gain not less than 1.00 or the blue gain less than 1.00.

7. The white balance control method as recited in claim 5, wherein the comparison of the first white balance gains to the white balance conditional thresholds of Status S and Status S−1 is given as a red gain of the first white balance gains is greater than 0.5 and a blue gain of the first white balance gains is less than 2.5 and the red gain less than 1.00 or the blue gain not less than 1.00.
